(19) United States
(12) Patent Application Publication
(10) Pub. No.: US 2010/0174625 A1
(43) Pub. Date: Jul. 8, 2010

(54) Method and System for Awarding Points for Purchases for Purposes of Providing Humanitarian Aid

(75) Inventor: Robert Landures Steed, Springville, UT (US)

Correspondence Address: HOLME ROBERTS & OWEN, LLP, 299 SOUTH MAIN, SUITE 1800, SALT LAKE CITY, UT, 84111, US

(73) Assignee: TRIVANI INTERNATIONAL, LLC, Springville, UT (US)

(21) Appl. No.: 12/349,012

(22) Filed: Jan. 6, 2009

(51) Int. Cl. G06Q 30/00; G06Q 20/00; G06Q 10/00; G06Q 50/00; G06F 17/30; G06F 17/40

(52) U.S. Cl. 705/30; 705/40

(57) ABSTRACT

A system is described for providing humanitarian aid. The system includes means for providing a sponsored item for sale at a merchant. The sponsored item is associated with a corresponding point value used for purposes of providing humanitarian aid. Means are provided for registering a purchase of the sponsored item at the merchant. The system includes means for determining the corresponding point value for the purchased sponsored item. This is accomplished, by cross-referencing a first database that stores an identification code and corresponding point value for the sponsored item. Further, means for associating the point value with a donation is included within the system. The donation is targeted to a recipient for providing humanitarian aid. In addition, means for determining a donation amount for the donation is included within the system. Means for distributing the donation to the recipient is also included within the system.

### CROSS REFERENCE TO RELATED APPLICATIONS

This patent application is related to the co-pending patent application Ser. No. ______, attorney docket number 52957-10100, entitled “Method and System for Utilizing Purchase Upgrades for Purposes of Providing Humanitarian Aid,” with filing date ______, and assigned to the assignee of the present invention, which is herein incorporated by reference in its entirety.

### BACKGROUND OF THE INVENTION

1. Field of Invention

The present invention relates to the field of marketing of a purchasable item. Specifically, the present invention relates to awarding points in association with one or more purchases of sponsored items for the purposes of providing of humanitarian aid.

2. The Relevant Technology

At the retail level, consumers are presented with a myriad of competing goods and services. Various marketing techniques are utilized to try to capture the attention of a consumer to purchase a particular good or service. For some companies, huge amounts of resources are spent in attracting a consumer in order to maintain and grow market share.

In one type of promotion, retailers sponsor various forms of savings programs. In general, a retailer offers to its consumers membership in a savings program. Typically, membership is free or offered at very minimal cost to the consumer. The minimal cost may be monetary, or based on some other valuation, such as information. In the latter case, the consumer is provided membership in the savings program in return for personal information (e.g., name, address, income, etc.) related to the consumer.

A retailer is able to promote specific products through a corresponding savings program. These identified products are offered by the retailer at a discounted price to members in the savings program. For instance, a tag may be placed on the shelf holding the product that notifies the consumer of the potential savings, if the product is purchased. Non-members still pay the regular price on the identified products.

As a marketing tool, the savings program promotes those products that are discounted, especially if the promoted product is one that the consumer is wanting to purchase. When presented with multiple brand choices for a particular type of product, member consumers may prefer to purchase the promoted product that is offered at a discount, rather than purchase a competing product.

Additionally, the retailer may continually shift products that are discounted as part of the savings program. As such, each time a consumer comes to shop, different products are being promoted. By changing promotions, the retailer may generate interest in new or different products. For instance, though initially not interested, a member consumer may be enticed to purchase a promoted product because of the additional discount provided in the savings program. This may lead to future purchases of the product, even though it may not be discounted.

In addition, the savings program may generate retailer loyalty. A member consumer may choose to shop at a retailer with a savings program, as opposed to a similar retailer without a savings program. However, advantages gained from a retailer having a savings program may be diminished as other competing retailers sponsor their own savings programs. To the consumer, if all the retailers have similar savings programs, each retailer is indistinguishable from the others, and the consumer may be reluctant to frequent one retailer over another retailer.

### SUMMARY OF THE INVENTION

What is needed is an invention that provides a new way of marketing to consumers that is capable of distinguishing items for purchase over other similar items, or for one retailer over another retailer. What is described in the present invention is a system and a method for implementing a program that awards points relating to purchases of sponsored items for the purposes of providing humanitarian aid. Specifically, the purchase of sponsored products participating in the program is associated with the provision of humanitarian aid.

In one embodiment, a system is described for providing humanitarian aid. The system includes means for providing a sponsored item for sale at a merchant. More specifically, the sponsored item is associated with a corresponding point value in a program awarding points related to purchases of sponsored items for the purposes of providing humanitarian aid. Also, means are provided for registering a purchase of the sponsored item by a consumer at the merchant. That is, at the merchant, the purchase of the sponsored item is recognized and acknowledged. The system includes means for determining the corresponding point value for the purchased sponsored item. This is accomplished, in part, by cross-referencing a first database that stores an identification code and corresponding point value for the sponsored item. Further, means for associating the point value with a donation is included within the system. The donation is targeted to a recipient for providing humanitarian aid. In addition, means for determining a donation amount for the donation is included within the system. Means for distributing the donation to the recipient is also included within the system.

In another embodiment, a method for providing humanitarian aid is described. The method can be implemented in association with a merchant that provides items for purchase. The method includes providing at least one sponsored item for purchase. Each of the sponsored items is associated with a corresponding point value in a program that awards points related to purchases of sponsored items for the purposes of providing humanitarian aid. Identification codes and corresponding points values are stored in a first database for the at least one sponsored item. In addition, purchases of one or more sponsored items are registered. Also, the method includes determining a corresponding point value for each sponsored item that is purchased by cross-referencing identification codes in the first database for the purchased items. A total point value is determined for the one or more sponsored items that are purchased. The total point value is associated with a donation to a recipient for purposes of providing humanitarian aid.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a system capable of providing humanitarian aid, in accordance with one embodiment of the present invention.

FIG. 2 is a flow diagram illustrating a method for providing humanitarian aid through the purchase of sponsored items as part of a program awarding points related to purchases of sponsored items for the purposes of providing humanitarian aid, in accordance with one embodiment of the present invention.

FIG. 3 is a data flow diagram illustrating the flow of information at a merchant offering items that when purchased are awarded points for the purposes of providing humanitarian aid, in accordance with one embodiment of the present invention.

FIG. 4 is a flow diagram illustrating a method that awards points when items are purchased for purposes of providing humanitarian aid, in accordance with one embodiment of the present invention.

FIG. 5 is a data flow diagram illustrating the flow of information at a point distribution center for converting points to a donation amount that is contributed to a donation given to a recipient for purposes of providing humanitarian aid, in accordance with one embodiment of the present invention.

FIG. 6 is an illustration of a status report 600 providing information related to a particular recipient, such as humanitarian aid program-A, in accordance with one embodiment of the present invention.

### DETAILED DESCRIPTION OF THE PREFERRED EMBODIMENTS

Reference will now be made in detail to the preferred embodiments of the present invention, methods and systems for providing humanitarian aid through the purchase of sponsored items provided as part of a program that awards points for purchases of sponsored items for purposes of providing humanitarian aid. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for humanitarian aid through consumer transactions. Specifically, the provision of humanitarian aid is associated with the purchase by consumers of sponsored items for purchase. Embodiments of the present invention are capable of distinguishing to the consumer sponsored items that when purchased provide humanitarian aid over regular, non-sponsored items beyond a price-point comparison. Further, embodiments of the present invention are capable of promoting sponsored items, which when purchased provide humanitarian aid, over regular, non-sponsored items.

Embodiments of the present invention are described within the context of sponsored items for purchase. It is intended that the term “item” includes anything and everything that is or may be presented to a consumer for purchase. For instance, an “item” includes goods, commodities, services, a package of multiple goods, package of multiple services, and a packaged combination of goods and services.

In addition, while some embodiments of the present invention are described within the context of providing humanitarian aid in association with a purchase of a sponsored item, other embodiments are well suited to providing any type of aid in association with the purchase of the sponsored item. For example, a donation made as a result of a purchase of a sponsored item can be made to any charitable organization or program (e.g., animal shelter, scholarship fund, etc.). As such, the purchase of a sponsored item can be directly associated with the implementation of any type of benefit or contribution.

### 1. Notation and Nomenclature

Embodiments of the present invention can be implemented on software or dedicated hardware running on a computer system. The computer system can be a personal computer, notebook computer, server computer, mainframe, networked computer, handheld computer, personal digital assistant, workstation, and the like. This software or hardware implemented program is operable for facilitating the provision of humanitarian aid through the purchase of sponsored items participating in a program awarding points for those purchases for the purposes of providing humanitarian aid. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “providing,” “associating,” “storing,” “registering,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### 2. Providing Humanitarian Aid Through Purchases of Sponsored Items

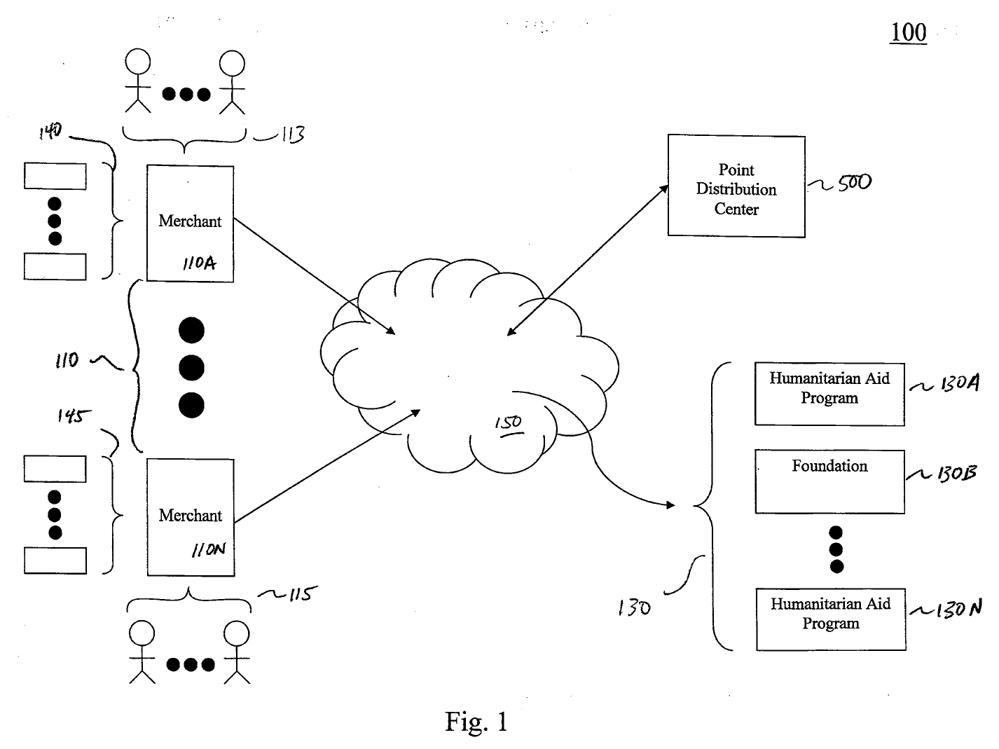

FIG. 1 is an illustration of a system 100 capable of providing humanitarian aid, in accordance with one embodiment of the present invention. Specifically, system 100 provides for the implementation of humanitarian aid as a direct or indirect result of the purchase of sponsored items.

System 100 includes means for providing a sponsored item for sale. The sponsored item is associated with a corresponding point value in a program awarding points related to purchases of sponsored items for the purposes of providing humanitarian aid. For example, means for providing a sponsored item includes providing the sponsored item for purchase at a merchant participating in the program. Other means are contemplated, such as provision of the sponsored item directly from the producer, manufacturer or provider of the sponsored item, without the use of a merchant; or through a mail-order catalogue; or through an internet based merchant. Still other means are contemplated for providing a sponsored item for sale.

As described previously, the term “item,” to include “sponsored item,” is representative of anything and everything that is purchasable by a consumer, such as one or more goods, one or more services, and a combination of goods and services. Also, it is important to note that the terms “consumer” or “consumer” is intended to include individual persons, a group of persons, companies, organizations, or any suitable category that is capable of purchasing the above defined item.

Embodiments of the present invention are described as being implemented within a program awarding points with the purchase of sponsored items, wherein the points directly or indirectly relate to the provision of humanitarian aid. One objective of the program is the promotion of one or more sponsored items for purchase. As such, each sponsored item is distinguishable over a similar item, also presented to the consumer, beyond a price point comparison. That is, the decision to purchase is made even if the sponsored item is more than, less than, or equal to the price of a similar, but non-sponsored item. As a result, the consumer's decision on whether to purchase one sponsored product over another similar non-sponsored product includes more than just a price-point comparison, and takes into consideration whether there is any other type of benefit provided. The benefit conferred, includes the provision of humanitarian aid as a result of the purchase of the sponsored item. In addition, additional benefits can be conferred to the participating consumer who purchases the sponsored item, to include an uplifting emotional benefit gained by knowing that the purchase is providing humanitarian aid, to a financial benefit (e.g., a tax break for charitable donations, etc.).

For purposes of illustration, a program can be implemented in a grocery store. The grocery store provides a sponsored item for purchase. In fact, the grocery store may provide one or more sponsored items for purchase. Looking at one sponsored item, the grocery store may also provide similar, but non-sponsored items. For instance, one sponsored item is a loaf of white bread. While the grocery store provides a multitude of brands of white bread for the consumer to choose from, one of the brands is associated with a sponsored loaf of white bread. As such, that sponsored loaf is distinguished over the other loafs that are not participating in the program for providing humanitarian aid, through the purchase of sponsored items. A participating consumer who purchases a sponsored loaf thereby participates in a program that is providing humanitarian aid.

Ideally, there is no added cost to the purchase price of the product that is participating the program awarding points for providing humanitarian aid, in one embodiment. As such, to the consumer, an additional cost is not passed on compensating for any humanitarian aid given. To the consumer, the sponsored item may now be more attractive over similar items, that are cheaper due to a sales promotion (e.g., through a savings member program, or through a storewide sale of that item), because there is humanitarian aid provided with the purchase of the sponsored item. As such, an additional reason, beyond a price-point comparison, to purchase a sponsored item is provided to the consumer in addition to the price comparison analysis.

The scope of the program can be expansive or limited, depending on the circumstances. For instance, the program can be implemented on worldwide, country-regional (e.g., including parts of different countries), national, nation-regional (e.g., including parts of a single nation), or local (e.g., city, suburb, merchant, consumer, etc.) levels. Further, the scope of the program can be limited to one or more merchants at the national, regional, or local level. For example, the program may be implemented through a single chain of merchants operating at different locations (a chain of grocery stores), and as such, the chain of merchants is the sponsor of the items. Consumers wanting to participate in the program, in that region, then must purchase the sponsored products at one of the merchants in that chain. In addition, the scope of a program can be further limited to one or more sponsored products, at the national, regional, or local level, and as such, the producer of the item is the sponsor. For example, a sponsored product may be offered at different merchants in one region. Any purchase of that sponsored product, no matter the merchant, allows for participation in the program that provides humanitarian aid. Of course, a combination of merchant and producer may participate in a program providing humanitarian aid through the purchase of sponsored items.

As shown in FIG. 1, system 100 includes a plurality of merchants 110 (e.g., merchants 110A-N). Each of the merchants provides an avenue for one or more associated consumers to purchase one or more sponsored items. For example, one merchant includes a conventional, retail store, in which a transaction completing the purchase of a sponsored item occurs mostly at the location of the store. That is, the consumer travels to the store, sees or understands the sponsored item for purchase, and purchases the sponsored item at the store. These stores are situated in various locations, such as in a stand-alone building, a strip mall, a mall, a lot for outdoor display of larger items (e.g., cars, boats, recreation vehicles, farm equipment, etc.), outside venue, etc. Also, merchants includes other types of businesses, such as restaurants, movie theaters, etc. Other merchants include those effecting electronic commerce, such as sites on the internet offering items for purchase. In addition, other merchants include companies that are offering services, such as auto maintenance/repair, construction labor, broker of insurance plans, tax preparation services, mortgage services, attorney services, etc. As can be seen, any merchant suitable for offering an item for purchase is included within the plurality of merchants 110.

It is important to note that each of the merchants may be able to provide non-sponsored items also for purchase, in one embodiment. In short, a merchant provides a plurality of items for purchase to a plurality of consumers. Included within the plurality of items is one or more sponsored items participating in a program providing humanitarian aid as a result of purchases of sponsored items. For instance, merchant 110A provides a plurality of sponsored items 140 for purchase to a plurality of consumers 113. Also, merchant 110N provides a plurality of sponsored items 145 to a plurality of consumers 115.

Also, the plurality of sponsored items, provided for purchase at a single merchant, may be associated with one or more producers. For instance, in the case of a grocery store participating as a merchant as a sponsor in a program providing humanitarian aid, the merchant may provide a loaf of bread as a sponsored item, and a can of beans as another sponsored item. The loaf of bread is made by one producer, while the can of beans is made by another producer. It is important to note that these items may also be sponsored by the producer, independently of or in conjunction with sponsorship by the merchant.

There may be some overlap in products and consumers within the plurality of merchants. For instance, merchants 110A and 110N may provide the same sponsored item for purchase. Also, a single participating consumer may purchase sponsored items at both merchants 110A and 110N.

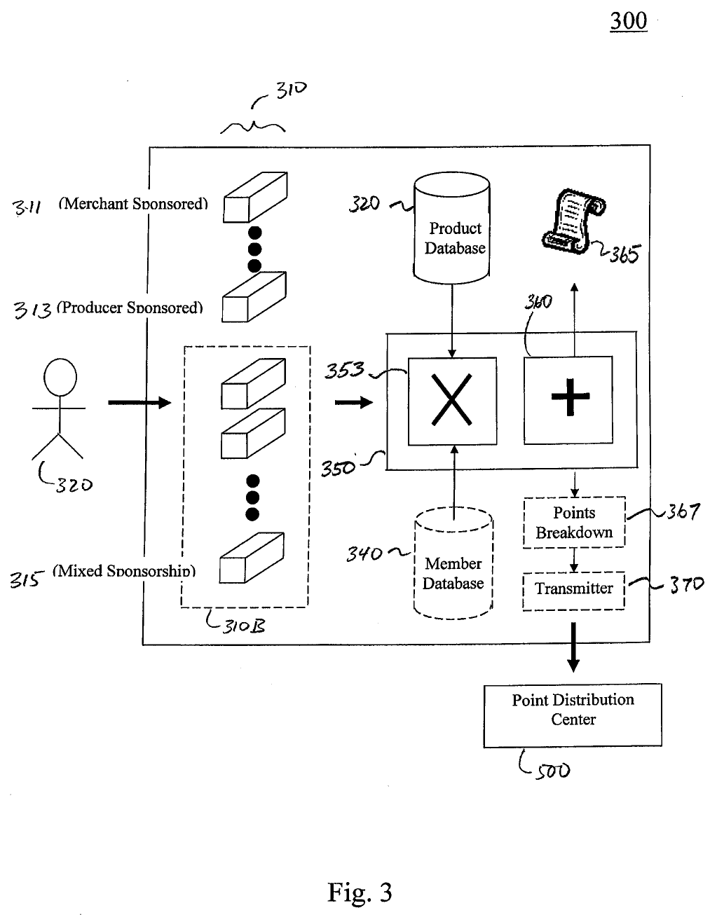

The system 100 also includes means for registering a purchase of sponsored items. For instance, system 100 also includes means for registering a purchase of a sponsored item by a participating consumer at a merchant. In one case, a tracking/notification module 350, of FIG. 3, at the merchant is capable of recognizing when a purchase of a sponsored item is made by the participating consumer. For instance, a tracking/notification module at merchant 110A tracks purchases of sponsored items made by participating consumers. In one implementation, a scanning mechanism that takes advantage of any number of bar code systems may be implemented to track and recognize a purchase of a sponsored item by a participating consumer at a merchant. A more detailed discussion on registering a purchase of a sponsored item is provided in relation to FIG. 3.

The system 100 also includes means for determining a corresponding point value for a sponsored item that is purchased. For instance, a database is included within system 100 that stores an identification code for the sponsored item. In addition, the database includes a corresponding point value that is associated with the purchase of the sponsored item.

The point value is associated with a donation to a recipient (e.g., humanitarian aid program) for purposes of providing humanitarian aid. As an example, a notification of the purchase of the sponsored item is provided by the tracking/notification module 350. Specifically, the tracking/notification module 350 sends the point value from the corresponding merchant to a point distribution center 500 for purposes of distributing the donation. A more detailed discussion on determining a corresponding point value is provided in relation to FIG. 3.

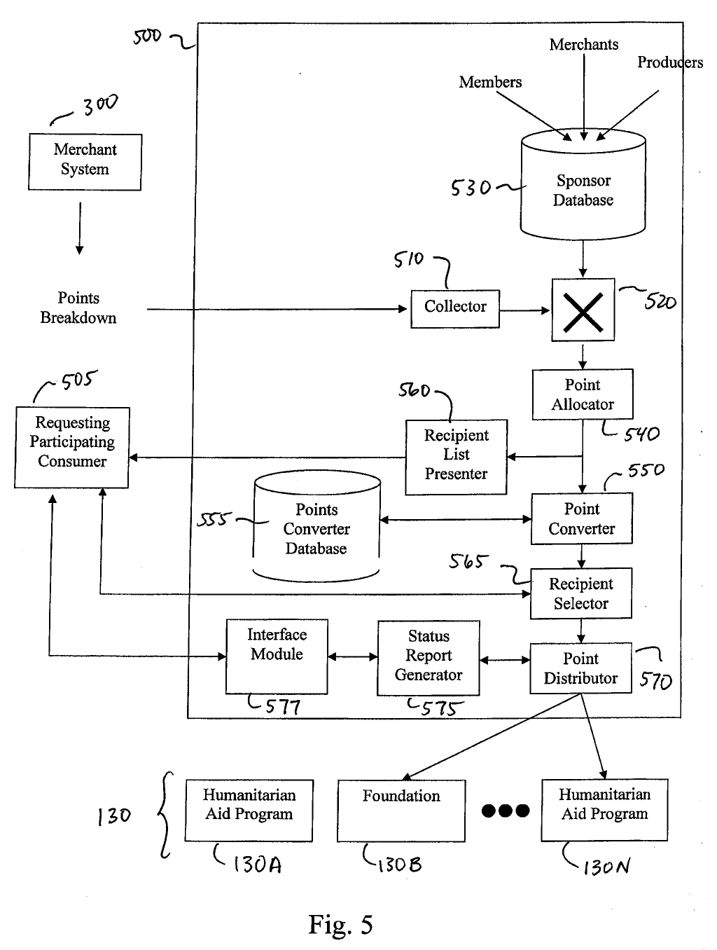

The system 100 also includes means for determining a donation amount for the donation. For instance, the means can include a converter that converts the point value into a donation amount that is provided to a humanitarian program for purposes of providing humanitarian aid. These means may be located at the point distribution center 500. A more detailed discussion on determining a donation amount is provided in relation to FIG. 5.

System 100 also includes means for distributing the donation to the recipient. For instance, upon notification of the point value associated with a purchase of a sponsored item, the point distribution center 500 is able to distribute the donation to one or more of the plurality of recipients 130 for purposes of providing humanitarian aid. Point distribution center 500 may be located remotely from the plurality of merchants 110, in order to receive notifications of the purchase of sponsored items from each of the merchants. In addition, the point distribution center 500 may be located at one of the plurality of merchants 110 to receive notifications of the purchase of sponsored items. In still another case, the point distribution center 500 is dedicated to a particular merchant. As such, contribution distributor 300 would be located at a specific merchant to provide for humanitarian aid in association with a purchase of an upgraded item at that specific merchant outlet.

In one embodiment, the selection of a recipient is dependent on the choice of the sponsor of the item (e.g., merchant or producer). In another embodiment, the selection of a recipient is determined by the participating consumer making the purchase, such that the consumer is able to control which recipient receives the donation. As such, with the purchase of a sponsored item, the participating consumer is in a sense directly responsible for providing humanitarian aid through the distribution of a donation. A more detailed discussion on distributing the donation is provided in relation to FIG. 5.

The plurality of recipients 130 shown in FIG. 1 is representative of any number of programs that provide humanitarian aid. It is also envisioned that a humanitarian aid program may be a charitable foundation (e.g., foundation 130B) through which humanitarian aid is distributed through any number of derivative projects or programs.

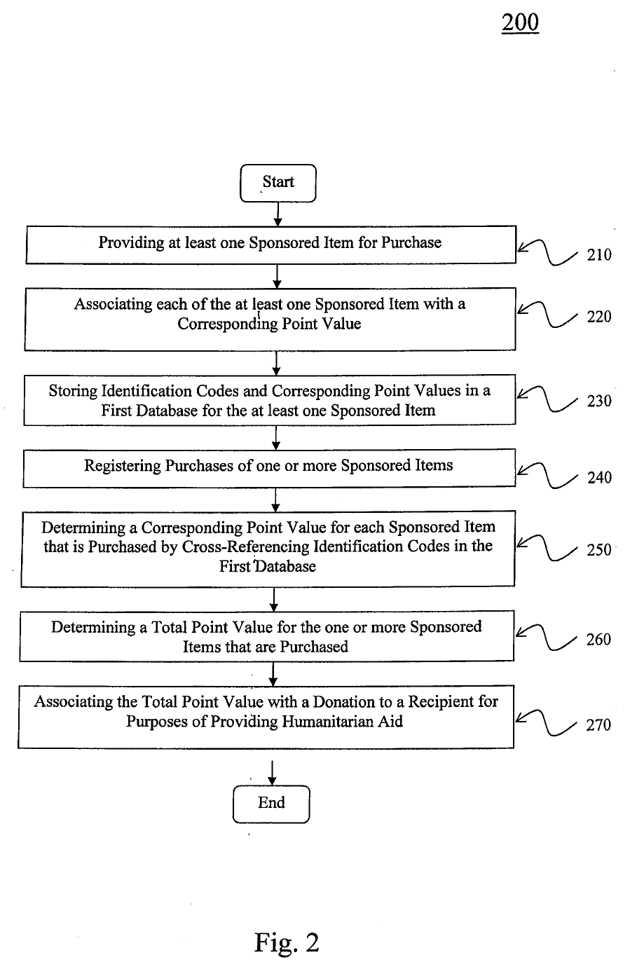

FIGS. 2 and 3 illustrate the implementation of a program that awards points relating to purchases of sponsored items for the purposes of providing humanitarian aid. These figures describe a relationship between the participating consumer and the merchant providing the sponsored items for purchase.

Specifically, in FIG. 2, a flow diagram 200 illustrates a method for providing humanitarian aid through the purchase of sponsored items, in accordance with one embodiment of the present invention. In addition, FIG. 3 is a data flow diagram illustrating the flow of information at a merchant offering items that when purchased are awarded points for the purposes of providing humanitarian aid, in accordance with one embodiment of the present invention.

As shown in FIG. 2, at 210, at least one sponsored item is provided for purchase. As previously described, each sponsored item is provided by a merchant for purchase by consumers. The sponsor of the sponsored item may be any number of participants in the program awarding points for purchases of sponsored items, including the merchant, and the producer of the product. As such, the sponsor enables the provision of humanitarian aid in relation to the purchase of the sponsored item.

As described previously, the item includes anything and everything that can be purchased by a consumer, to include goods, services, or a combination of goods and services, as examples. For instance, the item may be goods (e.g., an automobile, drink, loaf of bread, restaurant menu items, etc.), services (an insurance plan, a maintenance service plan for an automobile, professional service, labor services, etc.), a package of goods, a package of services, a package of a combination of goods and services, etc.

For instance, FIG. 3 illustrates a system 300 that is implemented at a merchant for purposes of providing humanitarian aid in a program awarding points for purchases of sponsored items. The merchant provides for purchase a plurality of sponsored items 310. The merchant may also provide a plurality of non-sponsored items (not shown) for purchase. The system 300 may be consolidated into a single unit, or distributed throughout a communication network. In either case, the modules of the system 300 are capable of communicating with each other to implement the program providing humanitarian aid.

As shown in FIG. 3, some items may be sponsored by the merchant (e.g., item 311), or some entity affiliated with the merchant (e.g., corporate parent). As such, in the program awarding points for purchases for purposes of providing humanitarian aid, the merchant is sponsoring the item within the program, and is associated with providing humanitarian aid with the purchase of the sponsored item. For instance, the merchant is responsible for providing humanitarian aid by contributing a donation

On the other hand, some items may be sponsored by the producer of the sponsored product (e.g., item 313). As such, in the program awarding points for purchases for purposes of providing humanitarian aid, the producer is sponsoring the item within the program, and is associated with providing humanitarian aid with the purchase of the sponsored item. That is, in this case, even though the merchant sells the product to the participating consumer at the retail level, it is the producer that is responsible for providing humanitarian aid. For instance, it is the producer of the sponsored item that contributes a donation for the provision of humanitarian aid.

In still another case, some items may be associated with a mixed sponsorship (e.g., item 315). For instance, in the program awarding points for purchases of providing humanitarian aid, both the merchant and the producer is sponsoring the item within the program, and are both associated with providing humanitarian aid with the purchase of the sponsored item. As such, both the merchant and the producer contribute the donation for the provision of humanitarian aid.

Returning back to FIG. 2, at 220 each of the sponsored items is associated with a corresponding point value that is earned upon being purchased by a participating consumer. That is, in the program providing humanitarian aid, each of the sponsored items is assigned a point value. The point value may be zero or greater, and not necessarily limited to integer values. For higher value items, their point values may be greater, though as a percentage they may be equal to lesser value items. In other embodiments, the percentages may vary depending on the sponsored item.

In one embodiment, a tag is provided at the point of purchase for each sponsored item. More specifically, each of the sponsored items is labeled with its corresponding point value using the tag. In that way, the consumer is able to distinguish the sponsored item from a similar item that is not participating in a program that provides humanitarian aid with the purchase of sponsored items. Also, the label provides the consumer with a sense of how much humanitarian aid is given, by reading the corresponding point value.

In one embodiment, the label or tag is placed directly on the sponsored item to provide an association between the sponsored item and the label. In another embodiment, the label or tag is placed near the sponsored item, such that an association can be made between the sponsored item and the label. For instance, a tag placed on the shelf holding the sponsored product notifies the consumer that here is a sponsored item and its corresponding point value in the program for providing humanitarian aid.

In one embodiment, the association between a recipient providing humanitarian aid program and the purchase of an sponsored item is promoted. Specifically, in an effort to stimulate the purchase of the sponsored item, the consumer is notified that in conjunction with the purchase, humanitarian aid is provided. For example, the consumer is notified that a portion of the cost or sale of the sponsored item will be donated to a specific, and sponsored humanitarian aid program. This notification may be provided on the label or tag.

Because of the benefit of providing humanitarian aid, the consumer may have additional motivation to purchase the sponsored item. For instance, the consumer may personally feel better when making the purchase of the sponsored item. As such, the consumer not only gains a material benefit from the purchase of the sponsored item, but also an emotional benefit knowing that the purchase is directly related to the provision of humanitarian aid.

At 230, identification codes and corresponding point values are stored in a first database for sponsored items. That is, each sponsored item is assigned an identification code that is used to distinguish it from other sponsored items, and non-sponsored items as well. For instance, a bar code, or other similar information source, placed on a label of an item can be used to identify that item. That identification code is stored in the first database.

More specifically, the identification code is used to access information in the database related to the identification code and the associated sponsored item. For instance, each sponsored item is associated with a corresponding point value, as previously described above. As such, the first database also stores the corresponding point value for each of the sponsored items.

In reference to FIG. 3, the item database 320 includes the identification code and the corresponding point values for each of the plurality of sponsored items 310. Access to information related to a sponsored item stored in the database 320 is provided by cross-referencing database using the identification code, or other suitable means. For instance, information could include the sponsor of the sponsored item, corresponding point values, a conversion of points to donation amount associated with that sponsored item, the recipient of humanitarian aid that is associated with the purchase of the sponsored item, etc.

At 240, purchases of one or more sponsored items are registered. In one case, the purchases are associated with a single participating consumer at one merchant. For instance, using the grocery store example, a participating consumer is purchasing one or more sponsored items in one check-out transaction. Though the consumer may be purchasing a mixture of sponsored items and non-sponsored items, the present embodiment is able to recognize and register each of the sponsored items that are purchased by the participating consumer.

For example, a scanner can be used to read the bar codes of the items purchased by the consumer. The bar codes include the identification codes for sponsored items. As such, by cross-referencing database 320, it is possible to identify those sponsored items that were purchased by the participating consumer. Simultaneously, the price for those sponsored items can also be determined.

Still other embodiments are well suited to supporting registering purchases of one or more participating consumers at one or more merchants. That is, at 240, purchases are not limited to one consumer at one location, but may include multiple consumers purchasing sponsored items at multiple locations. For instance, in the example using a grocery store as a merchant, a grocery chain may collect all the electronic receipts of its transactions, and then go through the process of registering purchases of one or more sponsored items.

For example, returning back to FIG. 3, a tracking/notification module 350 is able to track and recognize when a purchase of a sponsored item has been made. In particular, the receiver 353 is able to track purchases of sponsored items, as well as non-sponsored items. As shown in FIG. 3, for illustration only, a participating consumer 320 has purchased a plurality of sponsored items 310B that is a subset of the plurality of sponsored items provided by the merchant.

The receiver 353 (e.g., a scanner) is able to recognize purchases of the sponsored items. More particularly, receiver 353 is able to access item database 320 to determine if a purchased item is a sponsored item. For instance, receiver 353 is able to access information in the database using the identification code of the item. Cross-referencing the information in the database 320 will determine whether the item is a sponsored item or a non-sponsored item, as well as providing additional information, such as the point value for a purchased sponsored item, the price of the item, etc.

Additionally, the program awarding points for purchases of sponsored items for purposes of providing humanitarian aid is implemented on a membership platform, in accordance with one embodiment of the present invention. Specifically, consumers who want to participate in the program providing humanitarian aid must also be members within the program. As such, unlike other embodiments, in the present embodiment, it is not enough to purchase the sponsored item, but the participating consumer must also hold a membership.

In embodiments, membership in the program is implemented on various levels. For instance, the program may be implemented on a local level, and more particularly through one or a few merchants. As such, the membership extends to consumers of those few merchants. On the other hand, the program may be implemented on a regional, or a national level. More particularly, the program is implemented through one or more merchants at one or more merchant outlets throughout the region or nation. As such, membership extends to consumers of those merchants at the regional and national level.

For example, turning back to FIG. 3, the tracking/notification module 350, and more particularly, the receiver 353 are able to enforce the membership requirement through a method of membership authorization. In particular, the receiver 353 is capable of receiving a member identification code from a participating consumer that is making purchases of one or more sponsored items.

The receiver 353 is also capable of verifying the member identification code associated with the consumer. This is accomplished by cross-referencing a second database 340 storing a plurality of valid member identification codes associated with a plurality of members participating in the program awarding points related to purchases of goods or services for the purposes of providing humanitarian aid. As such, the receiver 353 is able to receive and identify the member identification code provided by the consumer and verify that the code belongs to a valid member in the program. As such, any purchases of sponsored items can be associated with that member identification code and corresponding member.

Turning back to FIG. 2, at 250, a corresponding point value is determined for each sponsored item that is purchased by the participating consumer. This is achieved by cross-referencing identification codes in the first database, or item database 320, in one embodiment. That is, a comparator associated with or coupled to the receiver is able to determine corresponding point values for sponsored items that are purchased by cross-referencing the database 320. In the program for providing humanitarian aid, the corresponding point value for a particular item gives a value on the extent of humanitarian aid provided. Higher point values are associated with more humanitarian aid given. Additionally, the point values are cumulative, in one embodiment. That is, the more items purchased by particular consumer, even more humanitarian aid is given.

At 260, a total point value is determined for the one or more sponsored items that are purchased. That is, the corresponding point value for each sponsored item that is purchased is accumulated to generate the total point value that is earned. For instance, as shown in FIG. 3, the accumulator 360 receives the point values from the receiver 353, and adds them together to generate the total point value. As described before, the total point value may be from one transaction that is associated with one participating consumer, from transactions from multiple participating consumers at one or more merchant locations, or from any number of varying transactions.

At 270, an association is made between the total point value with a donation to one or more recipients for purposes of providing humanitarian aid. That is, a relationship is established to effect the provision of humanitarian aid based on the total point value.

In one embodiment, for illustration purposes only, for a single transaction from a single participating consumer, an association between the total point value and a donation given for purposes of providing humanitarian aid is provided to the consumer. For instance, at the end of the transaction, a receipt 365 is typically given to the consumer listing the items purchased and the total owing by the consumer to the merchant. The accumulator 360 is capable of providing the information in the receipt 365. Additionally, the receipt 365 may provide a listing of sponsored items that are purchased and the total point value earned for all the sponsored items that are purchased.

The receipt 365 may also provide notification that with the purchase of the sponsored items, humanitarian aid will be given. More specifically, a notification module informs the participating consumer of the total point value earned from purchasing sponsored items and the provision of humanitarian aid based on the total point value. For instance, the notification module may be receipt printer. As such, this provides to the participating consumer an association between the purchase of sponsored items and the provision of humanitarian aid. More specifically, the accumulator is capable of determining a donation amount that is reflective of the total point value earned by the participating consumer in the transaction. This donation amount is also provided in the receipt 365.

Also, the recipient of the donation amount can be given, if this information is known, or has been predetermined. In one embodiment, the recipient is known. For instance, the merchant is the sponsor of all sponsored items in the merchant outlet and has selected a recipient as the beneficiary of humanitarian aid (e.g., in the form of a donation). In another embodiment, multiple recipients are beneficiaries of humanitarian aid from the transaction. For instance, certain purchased items provide humanitarian aid to one recipient, while other purchased items provide humanitarian aid to other recipients. In still another embodiment, the participating consumer is able to choose the recipient, at the time of completing the transaction, or at a later time.

In still another embodiment, a program for providing humanitarian aid supports sponsorship of a child, or some other entity (e.g., village) by the participating consumer. Specifically, a participating consumer is able to sign on to sponsorship of a child, in one embodiment. In this case, the recipient is the sponsored child, or entity. All purchases of sponsored items by the participating consumer earn corresponding point values, which when converted provides funds for donations that are directed towards providing humanitarian aid for the benefit of the sponsored child. For instance, the donations are provided to a program that can provide humanitarian aid to the child. Over time, the participating consumer is able to continue sponsorship of the child by making additional purchases of sponsored items.

As shown in FIG. 3, module 367 is able to provide a points breakdown for the total point value. That is, the total point value is partitioned out to sponsored items that are purchased and their corresponding point values, by transactions by participating consumers, by consumers, by merchants, etc.

Additionally, the total point value and the points breakdown are sent by the communications module (e.g., transmitter 370) to the point distribution center 500. A more detailed discussion of the point distribution center 500 is provided in FIG. 5. To summarize, the point distribution center 500 allocates the points earned to various recipients, and provides the related donations to those recipients based on the total point value earned.

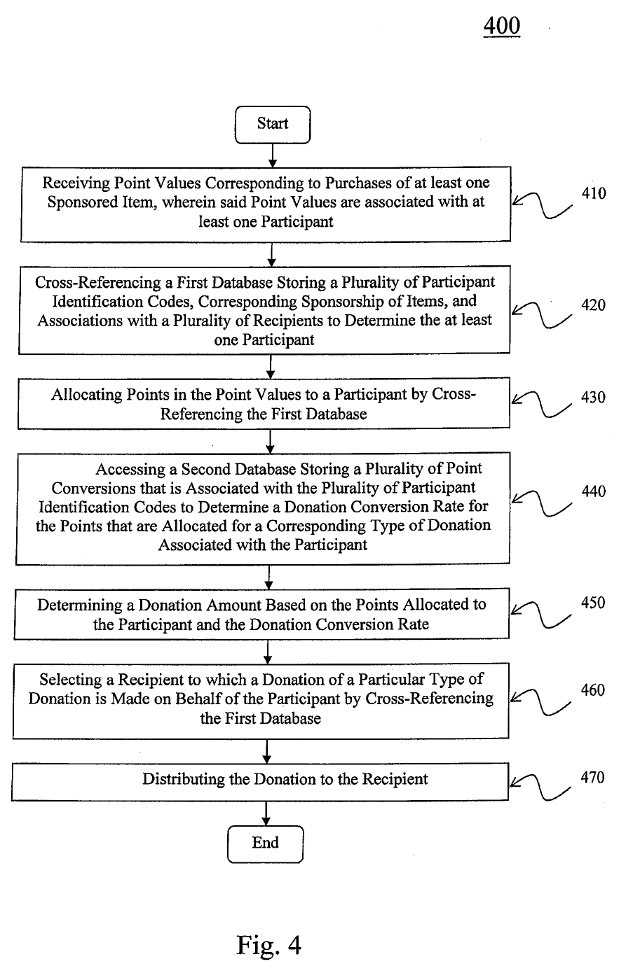

FIGS. 4 and 5 illustrate the implementation of a program that awards points relating to purchases of sponsored items for the purposes of providing humanitarian aid. These figures describe a relationship between the participating consumer, the merchant providing the sponsored items for purchase, and the point distribution center that allocates donations to one or more recipients based on points earned when purchasing sponsored items. The relationship is described from the viewpoint of the point distribution center for processing transactions related to providing humanitarian aid, in one embodiment.

Specifically, in FIG. 4, a flow diagram 400 illustrates a method that awards points when items are purchased for purposes of providing humanitarian aid, in accordance with one embodiment of the present invention. In addition, FIG. 5 is a data flow diagram illustrating the flow of information at a point distribution center for converting points to a donation amount that is contributed to a donation given to a recipient for purposes of providing humanitarian aid, in accordance with one embodiment of the present invention.

Point distribution center 500 may be located remotely from the plurality of merchants 110, in order to receive notifications of the purchase of sponsored items from each of the plurality of merchants. In addition, the point distribution center 500 may be located at one of the plurality of merchants 110 to receive notifications of the purchase of sponsored items from each merchant, including remote merchants. In still another case, the point distribution center 500 is dedicated to a particular merchant. As such, point distribution center 500 would be located at a specific merchant to provide for humanitarian aid in association with purchases of a sponsored items at that specific merchant.

Turning now to FIG. 4, at 410, point values corresponding to purchases of at least one sponsored item are received. As previously described, point values are associated with each of the sponsored items. These point values are associated with a program providing humanitarian aid, and are awarded each time a sponsored item is purchased by a participating consumer.

Referring now to FIG. 5, point values are received at the point distribution center 500 from a merchant system 300. The point distribution center 500, first shown in FIG. 1, is capable of facilitating the provision of humanitarian aid with the purchase of sponsored items, in accordance with one embodiment of the present invention.

Point distribution center 500 may be consolidated into a single unit, as shown in FIG. 5, or distributed throughout a communication network. In either case, the modules of point distribution center 500 are capable of communicating with each other to facilitate the provision of humanitarian aid. As such, point distribution center 500 acts as the control center for the distribution of instructions or donations to programs for purposes of providing humanitarian aid as a result of a purchase of sponsored items.

More specifically, a breakdown of point values, to include a total point value, is sent from the merchant system 300 and received by a collector 510 in center 500. The point values correspond to purchases of at least one sponsored item, purchased by one or more participating consumers at one or more merchants. For example, the breakdown of point values may include an item by item list with corresponding point values and sponsorship information for a given period, or transaction, or series of transactions. On the other hand, the breakdown may include a total point value from each participating consumer for a given period, or transaction, or series of transactions. In addition, the breakdown may include a total point value from participating merchants for a given period, or transaction, or series of transactions. Also, the breakdown may include a total point value for all transactions over a certain period, or transaction, or series of transactions.

Returning now to FIG. 4, at 420, at least one sponsor that is associated with the sponsored items is determined. That is, each sponsored item is associated with a sponsor in the program for providing humanitarian aid. In most cases, the sponsor is responsible for effecting the humanitarian aid, such as providing a donation that facilitates the provision of humanitarian aid, and selecting the recipient of the donation. In other cases, one of the sponsors participates in the provision of humanitarian aid, but may not be directly responsible for providing a donation to facilitate the provision of humanitarian aid. For instance, a participating consumer, as a sponsor in this context, may select the recipient, but an overarching sponsor is responsible for providing the donation to facilitate the provision of humanitarian aid.

The one or more sponsors are determined by cross-referencing a first database that stores a plurality of sponsor identification codes. For instance, referring now to FIG. 5, a comparator 520 is able to access the sponsor database 530 to determine the sponsors of purchased items, as well as other affiliated information. As an example, for a particular sponsored item, the sponsor may be a merchant, producer of the item, or even the participating consumer who purchases the sponsored item. As such, database 530 includes information related to member identification codes associated with participating consumers making purchases of one or more sponsored items, merchant identification codes identifying merchants selling the sponsored items, and producer identification codes identifying producers or manufacturers of the sponsored items.

In addition, the database 530 stores other information, such as item/sponsor relationship, sponsor/recipient relationship, corresponding point values for each sponsored item, etc. As such, by cross-referencing the database 530, using the identification code for the sponsored item, or any other related identifier, the sponsor of the item is determined, and associations with one or more recipients of humanitarian aid that is associated with the sponsor is also determined.

Returning to FIG. 4, at 430, points are allocated to the various sponsors. As an example, the point allocator 540 of FIG. 5 is communicatively coupled to the comparator 520 and allocates points in the received point values to the various sponsors. That is, from the point values received at the collector 510, for each sponsor associated with the purchased sponsored items, a sub-total point value is determined. As such, accumulating all the sub-total point values for each of the sponsors will generate a total point value received by the collector 510 from the merchant system 300 for a given period.

By determining the sub-total point value for a given sponsor, it is then possible to determine how to best distribute or implement the provision of humanitarian aid. In particular, at 440, a donation conversion rate is determined for the allocated points for a corresponding type of donation that is associated with a participating sponsor. Also, one sponsor may provide donations to more than one recipient. In that case, the allocation of points associated with the sponsor would be distributed to all recipients.

As a representative example, point converter 550 in FIG. 5 is able to access a database 555 that stores a plurality of point conversions that is associated with the plurality of sponsor identification codes. That is, for a given sponsor that is sponsoring one or more items, a conversion rate is assigned that converts points to a corresponding donation amount for a corresponding type of donation. For instance, a given sponsor sponsors items A-N that are provided at one or more merchants. Each of the items is associated with a point value. In addition, a conversion rate is associated with each of the items. The conversion rate may be the same for all the items sponsored by the sponsor, in one embodiment. In another embodiment, the conversion rate is dependent on which item is sponsored or to which recipient a donation is given. That is, each item has an independent conversion rate for converting points to a donation amount. In any case, the points converter 550 is able to take in all the points allocated to a particular sponsor, determine who the recipients are as beneficiaries of the provision of humanitarian aid based on the allocated points, and to determine donation amounts for each of those recipients.

Returning back to FIG. 4, at 450, a donation amount is determined based on the points allocated to a sponsor and a corresponding donation rate. Specifically, for a given sponsor, a conversion rate is determined for the points allocated to that sponsor. As such, a donation amount is determined based on the points allocated to that sponsor and the corresponding donation conversion rate. If there are multiple conversion rates associated with the sponsor, the points allocator is able to further associate points to conversion rates, and to determine donation amounts for the given conversion rates. That is, total donation amounts are determined for each type of donation made on behalf of the sponsor.

At 460, a recipient is selected to which a donation of a particular type of donation is made on behalf of the sponsor. A type of donation may be in the form of monetary funds. As a representative example, as shown in FIG. 5, a recipient selector 565 is capable of selecting a recipient by cross-referencing the database 530. The selected recipient may be pre-selected by the sponsor and automatically associated with the sponsor, or may be dynamically assigned according to instructions provided by the sponsor. Specifically, database 530 includes sponsor/recipient associations, or instructions for determining the proper recipient or recipients. If there are multiple recipients, recipient selector 565 is able to select one or more recipients that are to receive donations made on behalf of the sponsor.

Additionally, recipient selector 565 is able to receive instructions from participating consumers for selection of a recipient. That is, instead of using a selection by the sponsor of the item, the sponsor may wish to have the consumer distribute the donation amount to one or more selected recipients. In this case, the database 530 may provide instructions for effecting consumer selection. For instance, one or more recipients may be presented by a presenter (e.g., within the recipient selector 565) for selection to the participating consumer 505 by the recipient selector 565. A receiver (e.g., within the recipient selector 565) is also able to receive a selection of a recipient by the participating consumer 505.

In one embodiment, the selection of a recipient is performed at the time of the purchase of the sponsored items. That is, the participating consumer may be presented with a list of recipients for selection at the time of the purchase of the sponsored items. The selected program is then associated with the purchase of the sponsored items, and the resulting total point value for purposes of providing humanitarian aid. In this case, the notification provided to the point distribution center 500 of the purchase of sponsored items includes the selected recipient associated with that purchase.

As described previously, the recipient may be a humanitarian aid program, or a foundation that is dedicated to providing aid through various humanitarian aid programs. For instance, as shown in FIG. 5, a plurality of recipients 580 is able to provide humanitarian aid. These recipients include foundations, humanitarian aid programs, and other types of programs that are capable of distributing humanitarian aid.

At 470, a donation is distributed to the recipient. That is, point distributor 570 of FIG. 5 is able to distribute the donation to the proper recipient. As shown in FIG. 5, donations are made to two recipients, foundation 130B and humanitarian aid program 130N. As previously described, foundation 130B acts as a manager for distributing funds to various charitable organizations, including humanitarian aid programs. If the donation is made in terms of funds, then point distributor distributes funds to the proper recipient. More specifically, for every recipient selected to receive donations based on the point values received and allocated, the point distributor 570 is able to distribute donations to the proper recipients. As an example, the point distributor 570 is able to send instructions to provide funds for the donation to an account held for the recipient.

In another embodiment, point distributor 570 provides instructions to facilitate the provision of specific acts of humanitarian aid through the associated recipient (e.g., humanitarian aid program). Specifically, a directed action may be associated with the purchase of the sponsored items. That is, given enough points, a directed action is implemented by the recipient, and may be facilitated through the allocation of funds specifically tied to achieving the directed action, instructions to achieve that action, etc. For example, the action may be to inoculate a village with a particular immunization shot. As such, every purchase of associated sponsored items is directly related to achieving the directed action, in this case, inoculation of a village.

As shown in FIG. 5, point distribution center 500 is also able to provide status reports back to requesting consumers. More specifically, the status report generator 575 is able to receive pertinent information from each of the recipients (e.g., humanitarian aid program), generate a corresponding status report for each recipient receiving donations or instructions to perform directed actions, and provide access to the reports to requesting participating consumers making the purchases of the sponsored items.

Interface module 577 provides an avenue for consumers to access the reports generated by the report generator 575. As examples, the consumer may access the interface module 577 from various locations, including a home computer, a mobile phone, a kiosk computer located at the outlet from which a purchase was made, etc.

As such, as consumers make purchases of sponsored items, they can become more aware of the impact they can have in providing humanitarian aid through a corresponding humanitarian aid program just by making a purchase. That is, the requesting consumer is able to gain access to the status report to gain a further understanding and appreciation of the efforts of the humanitarian aid program, as supported, in part, through the decision of the consumer to purchase a sponsored item.

For instance, in one embodiment, an identifier (e.g., number or name) is assigned to a purchase of sponsored items by a participating consumer in a transaction. The identifier is given to the consumer in association with the purchase of sponsored items. The identifier identifies the recipient that is directly associated with the purchase of the sponsored items in the transaction. As such, the identifier can be used by the consumer to determine the proper humanitarian aid program that benefits from the purchase of the upgraded item by the consumer.

In one case, the participating consumer 505 presents the identifier to the interface module 577 for purposes of accessing a status report. Specifically, interface module 577 is able to cross-reference the identifier with the proper recipient associated with the corresponding purchase of sponsored items in the transaction. Once the recipient is determined from the identifier, interface module 577 is also able to identify and access the status report for that recipient from the status report generator 575, and make that status report available to the requesting consumer. For instance, the status report is accessible by the consumer over a communication network (e.g., internet).

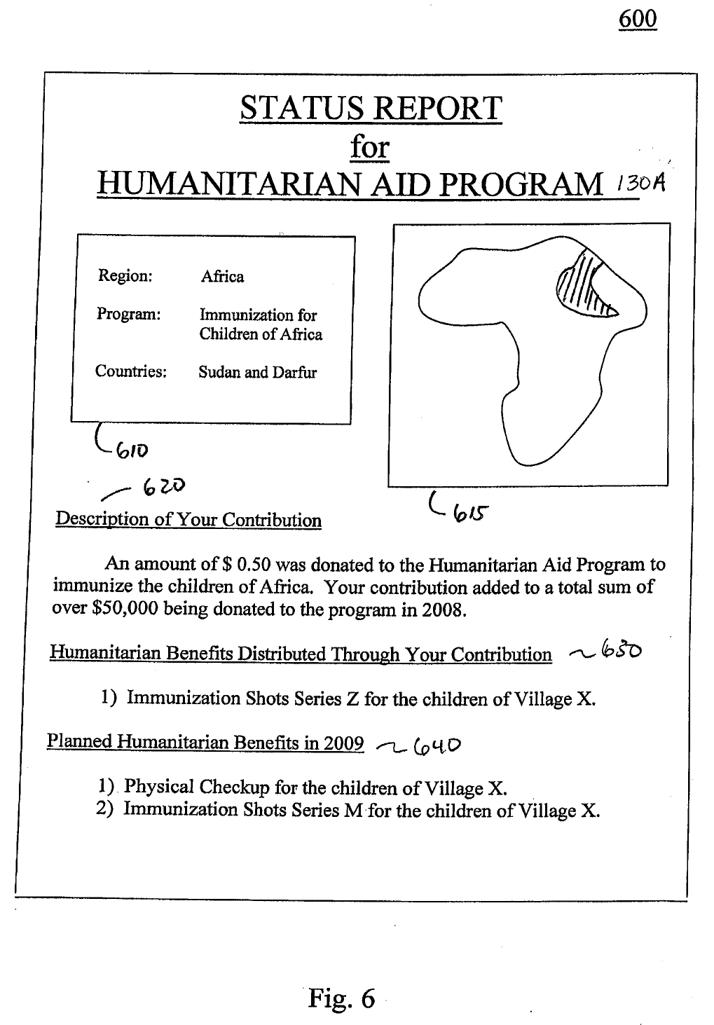

FIG. 6 is an illustration of a status report 600 providing information related to a particular recipient, such as humanitarian aid program 130A, in accordance with one embodiment of the present invention. As described previously, the status report 600 is managed and generated by the report generator 575 of the point distribution center 500. Access to the status report 600 is available through a server via a communication network (e.g., internet). As such, status report 600 is accessible through the interface module 577 of the point distribution center 500 by a consumer whose purchase of one or more sponsored items resulted in the provision of humanitarian aid through humanitarian program 130A. The status report 600 may be accessed by presenting an identifier that associates the purchase transaction with a corresponding humanitarian aid program.

Status report 600 is intended to provide an exemplary report for a corresponding recipient (e.g., humanitarian aid program 130A). Status report 600 may be configured to provide any type of information in whatever format. For instance, the information may be presented via text, graphics, audio, or any combination of these formats.

As shown in FIG. 6, Program 130A has chosen Africa as a region of focus, as is described in information block 610. Specifically, Program 130A is devoted to providing immunization to the children of Africa. Rather than taking on the whole continent, Program 130A is focusing its immunization efforts to the country of Sudan, and more particularly, in the western region of Sudan, such as the Darfur region.

At block 615, graphical or video images may be presented to the consumer showing the implementation of humanitarian aid. For instance, video images of children receiving immunization shots may be displayed in block 615. Once the video is completed, block 615 may return to the static display highlighting the country of Sudan benefiting from the consumer's purchase.

Under heading 620, the consumer is provided with a description of his or her contribution. As an example, a donation in the amount of fifty cents has been made to Program 130A. This donation was made in response to the purchase of one or more sponsored items. While the specific donation is relatively small, report 600 also provides information regarding the total sum donated to Program 130A as a result of consumers purchasing corresponding sponsored items (e.g., fifty-thousand in 2008).

Under heading 630, the consumer is provided with a description of specific actions that may have resulted from his or her purchase of sponsored item. These actions may have recently been performed, or are scheduled to be performed. For instance, the children of Village X received immunization shots from Series Z, as a result of the consumer's purchase of the sponsored items. It is understood that the purchase of the sponsored items facilitates the implementation of the actions listed under heading 430. That is, a single transaction supports the implementation of the actions, while a group of transactions of sponsored items may directly provide enough funds for the completion of the actions.

Under heading 640, a listing is provided of upcoming humanitarian aid to be received through the continued sponsorship of Program 130A. In that manner, the consumer gains a sense of responsibility towards Program 130A. This may result in the consumer providing further support of Program 130A through repeated purchases of sponsored items associated with the provision of humanitarian aid to Program 130A.

For instance, as shown under heading 640, planned distribution of benefits includes additional health programs for Village X. In one case, a physical checkup of the children of Village X is planned for the next year. In addition, additional immunization shots from Series M are planned to be given to the children of Village X in the next year.

Status report 600 may include other information, not shown. For instance, status report 600 may also include a listing of all the benefits received by a particular village, or individual (e.g., a sponsored child recipient). In this manner, the consumer is able to view this information and gain a sense of his or her involvement in the well being of a village, or specific individuals for that village.

While the methods of embodiments illustrated in flow charts 2 and 4 show specific sequences and quantity of operations, the present invention is suitable to alternative embodiments. For example, not all the operations provided for in the methods presented above are required for the present invention. Furthermore, additional operations can be added to the operations presented in the present embodiments. Likewise the sequences of operations can be modified depending upon the application.

A method and system for providing humanitarian aid through the purchase of sponsored items in a program awarding points for the provision of humanitarian aid are thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A system for providing humanitarian aid, comprising:
means for providing a sponsored item for sale, wherein said sponsored item is associated with a corresponding point value in a program awarding points related to purchases of sponsored items for the purposes of providing humanitarian aid;
means for registering a purchase of said sponsored item;
means for determining said corresponding point value for said sponsored item that is purchased by cross-referencing a first database that stores an identification code for said sponsored item and stores said corresponding point value that is associated with said sponsored item, wherein the point value is associated with a donation to a recipient for purposes of providing humanitarian aid;
means for determining a donation amount for said donation; and
means for distributing said donation to said recipient.

2. The system of claim 1, further comprising:
sending said point value to a points distributor, wherein said determining a donation amount and said distributing said donation are performed at said points distributor.

3. A system for processing transactions related to providing humanitarian aid, comprising:
a first database for storing a plurality of identification codes for a plurality of sponsored items for purchase, and for storing a corresponding point value associated with each sponsored item;
a receiver (e.g., scanner) for registering purchases of at least one sponsored item;
a first comparator coupled to said receiver and said first database for determining corresponding point values for said at least one sponsored item that is purchased, by cross-referencing said first database;
an accumulator coupled to said first comparator for determining a total point value for said at least one sponsored item that is purchased, wherein said total point value contributes towards providing humanitarian aid.

4. The system of claim 3, further comprising:
a notification module for informing a consumer making said purchases of said at least one sponsored item of said total point value and the provision of humanitarian aid based on said total point value.

5. The system of claim 4, wherein said notification module comprises a receipt printer.

6. The system of claim 1, further comprising:
a second database for storing a plurality of valid member identification codes associated with a plurality of members participating in a program awarding points related to purchases of goods or services for the purposes of providing humanitarian aid; and
a second comparator for identifying a member identification code for a consumer making said purchases of said at least one sponsored item, wherein said total point value is associated with said member identification code.

7. The system of claim 1, further comprising:
a communication module coupled to said accumulator for sending said total point value to a point distribution center, wherein said point distribution center allocates donations to one or more recipients based on said total point value.

8. The system of claim 7, wherein a recipient comprises a humanitarian aid program.

9. The system of claim 3, wherein said receiver comprises a scanner capable of recognizing said plurality of item identification codes.

10. The system of claim 3, wherein said at least one sponsored item is purchased by a consumer during a continuous transaction, and said total point value is associated with said continuous transaction.

11. A method for providing humanitarian aid, comprising:
providing at least one sponsored item for purchase;
associating each of said at least one sponsored item with a corresponding point value;
storing identification codes and corresponding point values in a first database for said at least one sponsored item;
registering purchases of one or more sponsored items;
determining a corresponding point value for each sponsored item that is purchased by cross-referencing identification codes in said first database;
determining a total point value for said one or more sponsored items that are purchased; and
associating said total point value with a donation to a recipient for purposes of providing humanitarian aid.

12. The method of claim 11, further comprising:
receiving a member identification code from a participating consumer making said purchases of said one or more sponsored items;
verifying said member identification code by cross-referencing a second database storing a plurality of valid member identification codes associated with a plurality of members participating in a program awarding points related to purchases of goods or services for the purposes of providing humanitarian aid; and
providing said association between said total point value and said donation to said participating consumer.

13. The method of claim 11, wherein said recipient comprises a humanitarian aid program.

14. The method of claim 11, wherein said recipient comprises a foundation.

15. The method of claim 11, further comprising:
sending said total point value to a point distribution center, wherein said point distribution center distributes said donation to said recipient.

16. The method of claim 11, further comprising:
providing notification to a consumer, making said purchase of said one or more sponsored items, of said total point value and its association with said donation.

17. The method of claim 11, further comprising:
labeling each of said at least one sponsored item with said corresponding point value.

18. The method of claim 17, wherein said labeling each of said at least one sponsored item further comprises:
providing a tag at a point of purchase for a corresponding sponsored item.

19. The method of claim 17, wherein said labeling each of said at least one sponsored item further comprises:
providing a tag on a package of a corresponding sponsored item.

20. A system for providing humanitarian aid, comprising:
a collector for receiving point values corresponding to purchases of at least one sponsored item, wherein said point values are associated with at least one sponsor;
a first database coupled to said collector for storing a plurality of sponsor identification codes (consumer, merchant, producer), corresponding sponsorship of items, and associations with a plurality of recipients;
a second database coupled to said first database for storing a plurality of point conversions that is associated with said plurality of sponsor identification codes, wherein each conversion converts points to a corresponding donation amount for a corresponding type of donation;
a point allocator for allocating points in said point values to a sponsor (could be dependent on the item, or the merchant, or consumer) based on said at least one item that is purchased by cross-referencing said first database;
a recipient selector for selecting, by cross-referencing said first database in relation to said sponsor, a recipient to which a donation of a particular type of donation is made on behalf of said sponsor; (because it could be to 2 or more recipients)
a converter coupled to said second database for determining a total donation amount of said donation based on said points allocated to said sponsor and said donation conversion rate; and
a points distributor coupled to said converter for distributing said donation to said recipient.

21. The system of claim 20, wherein said corresponding type of donation comprises monetary funds.

22. The system of claim 20, wherein said plurality of sponsor identification codes is taken from a group consisting essentially of:
a member identification code associated with a participating consumer making a purchase of one or more sponsored items;
a merchant identification code where a purchase of one or more sponsored items are made; and
a producer identification code, wherein an associated producer manufactures a corresponding sponsored item

23. The system of claim 20, wherein said recipient selector comprises:
a presenter for presenting one or more recipients to said participant for selection; and
a receiver for receiving a selection of said recipient.

24. The system of claim 20, wherein said plurality of recipients includes a foundation.

25. The system of claim 20, wherein said plurality of recipients includes a humanitarian aid program.

26. The system of claim 20, wherein said plurality of recipients includes a sponsored child.

27. The system of claim 20, further comprising:
an status report generator for providing for access to a status report regarding humanitarian aid provided by said recipient.

28. A method for providing humanitarian aid, comprising:
receiving point values corresponding to purchases of at least one sponsored item, wherein said point values are associated with at least one sponsor;
cross-referencing a first database storing a plurality of sponsor identification codes, corresponding sponsorship of items, and associations with a plurality of recipients to determine said at least one sponsor;
allocating points in said point values to a sponsor of said at least one sponsors based on said at least one sponsored item that is purchased by cross-referencing said first database;
accessing a second database storing a plurality of point conversions that is associated with said plurality of sponsor identification codes to determine a donation conversion rate for said points that are allocated for a corresponding type of donation associated with said sponsor;
determining a donation amount based on said points allocated to said sponsor and said donation conversion rate;
selecting a recipient to which a donation of a particular type of donation is made on behalf of said sponsor by cross-referencing said first database;
distributing said donation to said recipient.

29. The method of claim 28, wherein said selecting a recipient further comprises:
presenting one or more recipients for selection by said sponsor; and
receiving a selection of said recipient.

30. A method for providing humanitarian aid, comprising:
providing a sponsored item for sale, wherein said sponsored item is associated with a corresponding point value in a program awarding points related to purchases of sponsored items for the purposes of providing humanitarian aid;
registering a purchase of said sponsored item;
determining said corresponding point value; and
in association with said purchase, providing humanitarian aid.
